(19) United States
(12) Patent Application Publication
(10) Pub. No.: US 2010/0318463 A1
(43) Pub. Date: Dec. 16, 2010

(54) METHOD AND APPARATUS FOR ADDRESSING ISSUER HOLD FOR AUTOMATED FUEL DISPENSER TRANSACTIONS IN AN ELECTRONIC PAYMENT SYSTEM

(75) Inventors: Robert D. Reany, Wildwood, MO (US); Dennis J. Hill, St. Paul, MO (US); Sara E. Fiebiger, Ellisville, MO (US); Susan E. Riskovsky, O'Fallon, MO (US); Sandeep Malhotra, Ballwin, MO (US)

Correspondence Address: Otterstedt, Ellenbogen & Kammer, LLP, P.O Box 381, Cox Cob, CT, 06807, US

(73) Assignee: MasterCard International Incorporated, Purchase, NY (US)

(21) Appl. No.: 12/813,766

(22) Filed: Jun. 11, 2010

Related U.S. Application Data
(60) Provisional application No. 61/186,425, filed on Jun. 12, 2009.

(51) Int. Cl. G06Q 20/00

(52) U.S. Cl. 705/44

(57) ABSTRACT

Placement of a hold amount against a payment card account of a customer is facilitated, in response to the customer presenting a payment device, associated with the payment card account, in connection with a non-PIN, signature-based, dual-message transaction with a merchant. The presenting of the payment device is prior to a time when an amount of the transaction can be determined. Subsequent to the placement of the hold amount, immediately after the time when the amount of the transaction can be determined, transmission of an authorization advice message from an acquirer associated with the merchant to an issuer of the payment device is facilitated. The authorization advice message indicates the amount of the transaction. A further step includes facilitating the issuer of the payment device releasing any portion of the hold amount which exceeds the amount of the transaction, immediately responsive to the authorization advice message.

### CROSS-REFERENCE TO RELATED APPLICATIONS

This patent application claims the benefit of U.S. Provisional Patent Application Ser. No. 61/186,425 filed on Jun. 12, 2009 and entitled “METHOD AND APPARATUS FOR ADDRESSING ISSUER HOLD FOR AUTOMATED FUEL DISPENSER TRANSACTIONS IN AN ELECTRONIC PAYMENT SYSTEM.” The complete disclosure of the aforementioned Provisional Patent Application Ser. No. 61/186,425 is expressly incorporated herein by reference in its entirety for all purposes.

### FIELD OF THE INVENTION

The invention relates generally to electronic commerce, and, more particularly, to electronic payment systems.

### BACKGROUND OF THE INVENTION

Due to rising fuel prices, there has been an increase in consumer and media interest in the so-called “excessive hold” topic, as well as increased attention from policymakers. When using a credit card to purchase gasoline and pay at the pump, the card is typically presented at the beginning of the transaction before the amount of gasoline to be purchased, and thus the price, has been determined. It is possible that a person could present a valid credit card, but one which has insufficient credit available to purchase the amount of gasoline ultimately pumped into the vehicle. To protect gas station operators, a hold may be placed against the account to ensure sufficient funds to complete the purchase.

This approach may also be used in some circumstances when a debit card is used to purchase gasoline. There has been concern about the impact of holding Demand Deposit Account (DDA) funds based on estimated fuel purchases instead of actual purchase amounts for purchases where signature debit cards were used. In addition to the lack of availability of these funds, some consumers have reported that they have experienced overdraft fees resulting from excessive holds.

### SUMMARY OF THE INVENTION

Principles of the invention provide techniques for addressing issuer hold for automated fuel dispenser transactions in an electronic payment system. An exemplary embodiment of a method (which can be computer-implemented), according to one aspect of the invention, includes the step of facilitating placement of a hold amount against a payment card account of a customer, in response to the customer presenting a payment device, associated with the payment card account, in connection with a non-PIN, signature-based, dual-message transaction with a merchant. The presenting of the payment device is prior to a time when an amount of the transaction can be determined. An additional step includes, subsequent to the placement of the hold amount, immediately after the time when the amount of the transaction can be determined, facilitating transmission of an authorization advice message from an acquirer associated with the merchant to an issuer of the payment device. The authorization advice message indicates the amount of the transaction. A further step includes facilitating the issuer of the payment device releasing any portion of the hold amount which exceeds the amount of the transaction, immediately responsive to the authorization advice message.

One or more embodiments of the invention or elements thereof can be implemented in the form of a computer product including a tangible computer readable recordable storage medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

One or more embodiments of the invention can provide substantial beneficial technical effects; for example:
Compatibility with current industry practices and existing system capabilities.
Analogous to single-message advice mechanism thus minimizing the impact to the involved parties.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system that can implement techniques of the invention;

FIG. 2 depicts an exemplary inter-relationship between and among: (i) a payment network configured to facilitate transactions between multiple issuers and multiple acquirers, (ii) a plurality of users, (iii) a plurality of providers or other merchants, (iv) a plurality of acquirers, and (v) a plurality of issuers;

FIG. 3 shows a combined flow chart and block diagram, illustrative of data flow in an exemplary embodiment of a method and system, according to an aspect of the invention;

FIG. 4 is an exemplary system block diagram, according to another aspect of the invention; and

FIG. 5 is a block diagram of an exemplary computer system useful in one or more embodiments of the invention.

### DETAILED DESCRIPTION OF PREFERRED EMBODIMENTS

As noted above, due to rising fuel prices, there has been an increase in consumer and media interest in the so-called “excessive hold” topic, as well as increased attention from policymakers. When using a credit card to purchase gasoline and pay at the pump, the card is typically presented at the beginning of the transaction before the amount of gasoline to be purchased, and thus the price, has been determined. It is possible that a person could present a valid credit card, but one which has insufficient credit available to purchase the amount of gasoline ultimately pumped into the vehicle. To protect gas station operators, a hold may be placed against the account to ensure sufficient funds to complete the purchase.

As also noted above, this approach is typically used in circumstances when a (signature) debit card is used to purchase gasoline. There has been concern about the impact of holding DDA funds based on estimated fuel purchases instead of actual purchase amounts for purchases where signature debit cards were used. In addition to the lack of availability of these funds, some consumers have reported that they have experienced overdraft fees resulting from excessive holds. These isolated incidents have led to questions such as:

1. How long does the hold stay in effect?

2. Why is a hold put into place that exceeds a consumer's purchase?

3. Is a hold reconciled to the actual purchase or does it “age” off of the system?

There are variations in current industry practices that make these questions difficult to answer using current techniques, without long, sometimes technical, explanations. One or more embodiments of the invention address:
1. Obtaining timely and accurate data from the merchant and/or acquirer that reflects the final purchase amount.
2. Getting holds released by the issuer.

The method used to process a debit purchase (which impacts a DDA) is of significance. Some current systems process signature debit card transactions using techniques similar to those used for credit card transactions, utilizing a system that was built for credit card transactions. Since the credit business is based on a line of credit (rather than an actual account balance, as is the case with a debit card), close tracking of the Open to Buy (OTB) amount for credit cards has typically not been required. Use of a credit card system for debit transactions is now leading to issues with respect to practices previously considered standard, such as the above-discussed excessive holds against accounts

One or more embodiments of the invention employ features of an existing authorization advice message (based on ISO 8583) in a new way to communicate, in real-time, the final purchase amount from the merchant and/or acquirer to the issuer immediately after the purchase is completed.

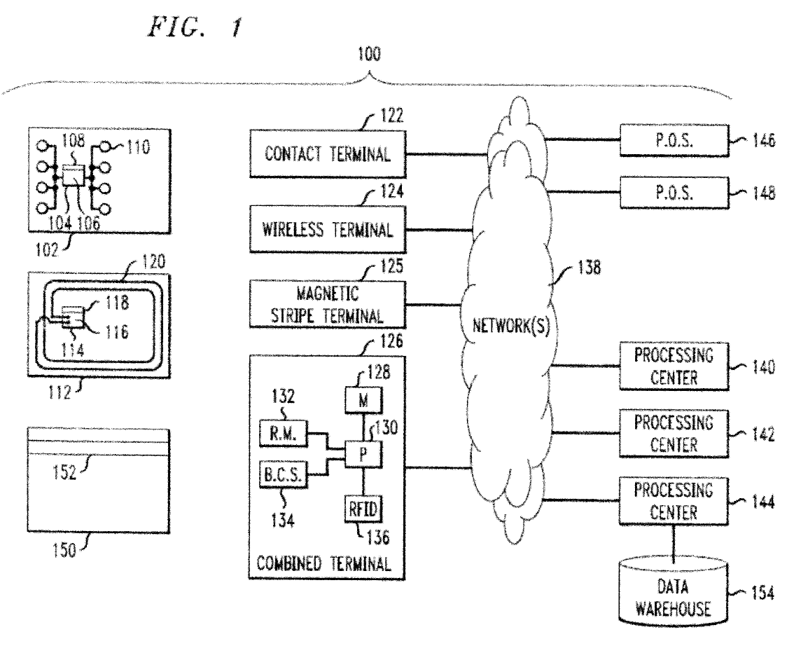

Attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. Other types of devices could include a conventional card 150 having a magnetic stripe 152, an appropriately configured cellular telephone handset, and the like. Indeed, techniques of the present invention can be adapted to a variety of different types of cards, terminals, and other devices, configured, for example, according to a payment system standard and/or specification.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic techniques.

The memory portions or units 108, 118 may include different types of memory, such as volatile and non-volatile memory and read-only and programmable memory (e.g., one or more EEPROMs). The memory units can store transaction card data such as, e.g., a user's primary account number (“PAN”) and/or personal identification number (“PIN”). Note that information about the PIN is included for completeness; however, one or more embodiments of the invention are limited to non-PIN transactions. The memory portions or units 108, 118 can store the operating system of the cards 102, 112. The operating system loads and executes applications and provides file management or other basic card services to the applications. One operating system that can be used to implement the present invention is the MULTOS® operating system licensed by MAOSCO Limited. (MAOSCO Limited. St. Andrews House, The Links, Kelvin Close, Birchwood, Warrington, WA3 7PB. United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card can be configured to conform to such EMV-compliant terminal behavior and in this sense is itself EMV-compliant. It will also be appreciated that applications in accordance with the present invention can be configured in a variety of different ways.

It should be noted that the skilled artisan will be familiar with the EMV specifications. Nevertheless, out of an abundance of caution, the following documents are expressly incorporated herein by reference in their entirety for all purposes (the same are published by EMVCo and available on EMVCo's web site):
EMV Integrated Circuit Card Specifications for Payment Systems Book 1 Application Independent ICC to Terminal Interface Requirements Version 4.2 Jun. 2008
EMV Integrated Circuit Card Specifications for Payment Systems Book 2 Security and Key Management Version 4.2 Jun. 2008
EMV Integrated Circuit Card Specifications for Payment Systems Book 3 Application Specification Version 4.2 Jun. 2008
EMV Integrated Circuit Card Specifications for Payment Systems Book 4 Cardholder, Attendant, and Acquirer Interface Requirements Version 4.2 Jun. 2008

As noted, cards 102, 112 are examples of a variety of payment devices that can be employed with techniques of the invention. The primary function of the payment devices may not be payment, for example, they may be cellular phone handsets that implement techniques of the invention. Such devices could include cards having a conventional form factor, smaller or larger cards, cards of different shape, key fobs, personal digital assistants (PDAs), appropriately configured cell phone handsets, or indeed any device with the capabilities to implement techniques of the invention. The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to facilitate execution of one or more method steps. The applications can be, for example, application identifiers (AIDs) linked to software code in the form of firmware plus data in a card memory such as an electrically erasable programmable read-only memory (EEPROM). Again, note that “smart” cards are not necessarily required and a magnetic stripe (or other technology) card can be employed.

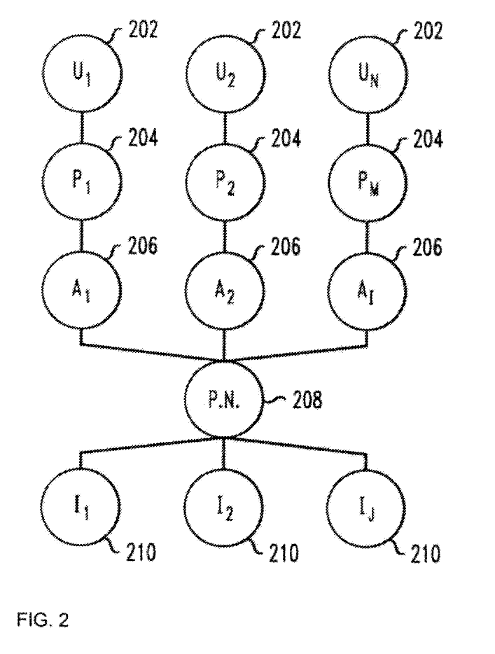

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below; the BANKNET® network (registered mark of MasterCard International Incorporated, Purchase, New York, USA) is a non-limiting example). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1. In one or more embodiments of the invention, the terminals 122, 124, 125, and/or 126 are located in, or adjacent to, gasoline or other automotive fuel pumps, and one or more of the points of sale 146, 148 are gasoline and/or other (e.g., diesel) filling stations.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

The portable device can include a body portion. For example, this could be a laminated plastic body (as discussed above) in the case of “smart” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. In some instances, the aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device. Magnetic stripe cards 150 can be swiped in a well-known manner.

One or more of the processing centers 140, 142, 144 can include a database such as a data warehouse 154 for storing information of interest.

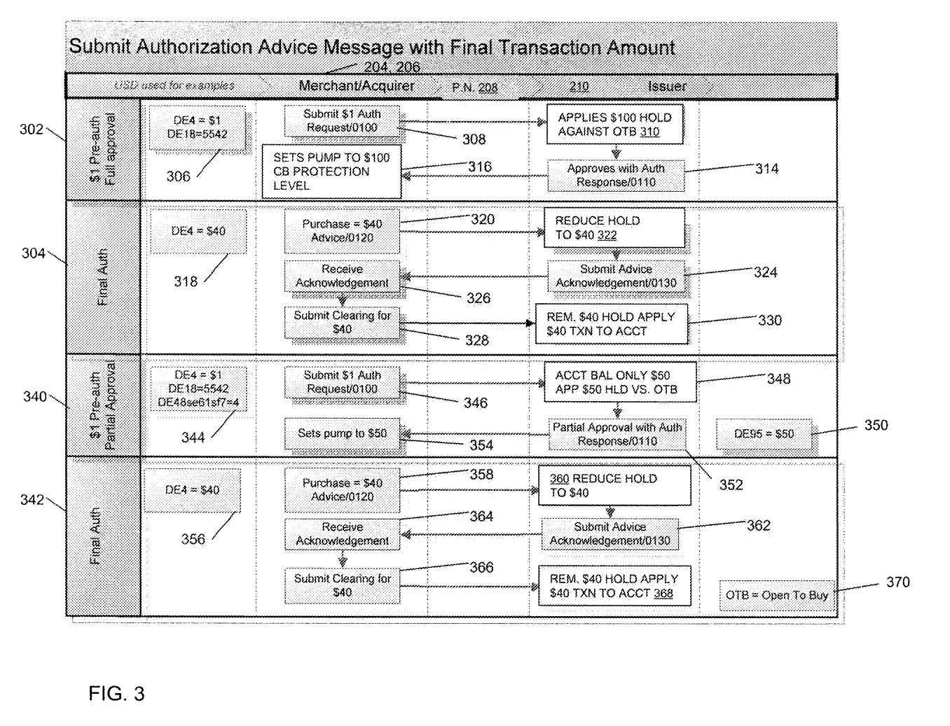

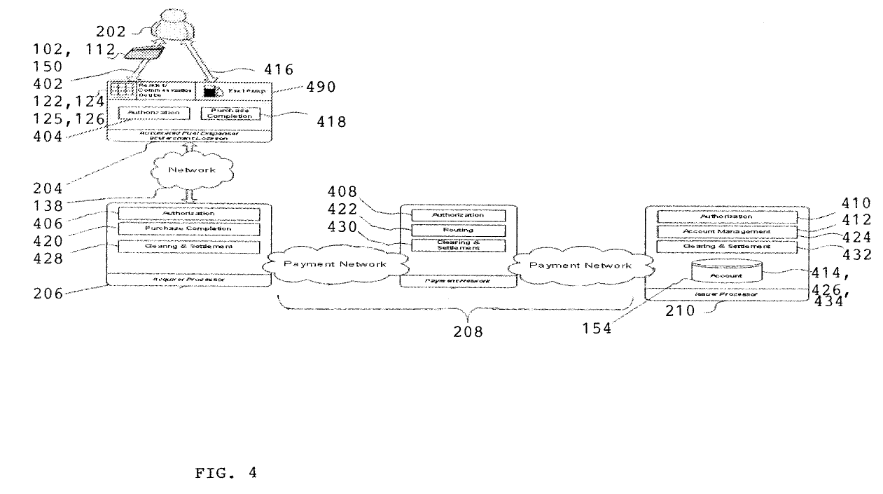

With reference to FIG. 2, an exemplary relationship among multiple entities is depicted. A number of different users 202, U₁, U₂ . . . U_{N}, interact with a number of different merchants 204, P₁, P₂ . . . P_{M}. In general, users 202 could be, for example, filling station customers, while merchants 204 could be, for example, filling stations. Merchants 204 interact with a number of different acquirers 206, A₁, A₂ . . . A₁. Acquirers 206 interact with a number of different issuers 210, I_{I}, I₂, . . . I_{J}, through, for example, a single operator 208 of a payment network configured to facilitate transactions between multiple issuers and multiple acquirers (which is one preferred form of network 138); for example, MasterCard International Incorporated, operator of the BANKNET® VPN, or Visa International Service Association, operator of the VISANET® VPN. In general, N, M, I, and J are integers that can be equal or not equal. In the context of one or more embodiments of the invention, such as those depicted in FIGS. 3 and 4, consumer 202 could hold a device such as 102, 122, 150; merchant 204 could have a terminal such as 122, 124, 125, 126, and any one or more of the entities 204, 206, 208, 210 (typically 206, 210) could operate processing centers such as 140, 142, 144 (with data storage 154 as needed).

Messages within a network such as network 138 and/or network 208, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part1: Messages, data elements and code values (2003 and 1987 versions)
ISO 8583 Part 2: Application and registration procedures for Institution Identification Codes (IIC) (1998)
ISO 8583 Part 3: Maintenance procedures for messages, data elements and code values (2003 and 1987 versions)

During a conventional credit authorization process, the cardholder 202 pays for the purchase and the merchant 204 submits the transaction to the acquirer (acquiring bank) 206. The acquirer verifies the card number, the transaction type and the amount with the issuer 210 and reserves that amount of the cardholder's credit limit for the merchant. Authorized transactions are stored in “batches”, which are sent to the acquirer 206. During clearing and settlement, the acquirer sends the batch transactions through the credit card association, which debits the issuers 210 for payment and credits the acquirer 206. Once the acquirer 206 has been paid, the acquirer 206 pays the merchant 204. One or more embodiments of the invention apply to dual-message transactions of the kind just described. For completeness, note that some acquirers may reconcile with their merchant prior to settlement, and then carry out adjustments after settlement.

In a single-message process, both authorization and clearing happen in the same message. In the dual-message process, the authorization is carried out online in real time and the clearing and settlement occur at a later time, as described above. In the single-message process, the authorization and clearing are both done at the same time, online.

One or more embodiments of the invention make use of debit cards, wherein the card-holder spends money in a DDA. Such debit cards typically carry a credit-card brand (such as, for example, MasterCard brand, Visa brand, American Express brand, or Discover brand) and can be used in similar ways (note that one or more preferred embodiments are in the context of a MasterCard-type or Visa-type system as shown in FIG. 2). Instead of checking a purchase against an available credit limit, it can be checked against the available DDA balance.

One or more embodiments of the invention address concerns regarding balance hold issues in debit card transactions by submitting an Authorization Advice Message with the final transaction amount. In particular, in one or more instances, when an authorization is submitted for an estimated fuel purchase amount, a suitable authorization advice message with the actual amount is required to be sent by the acquirer 206 immediately following the completion of the purchase. One specific non-limiting example of such an authorization advice message is an MTI 0120 Authorization Advice message. The skilled artisan will be familiar with the concept of the MTI (message type indicator) from the ISO 8583 Standard for Financial Transaction Card Originated Messages—Interchange message specifications, which is the International Organization for Standardization standard for systems that exchange electronic transactions made by cardholders using payment cards. As used herein, including the claims, “immediately” means that the authorization advice message is sent sufficiently quickly such that:

(i) the cardholder's open-to-buy is either not impacted in such a fashion that would cause any subsequent transactions to be declined as a result of the hold, or at least the chance of such an impact over a large population of users and transactions is small enough to be tolerable to users; and

(ii) the cardholder either does not experience an overdraft due to the hold, or at least the chance of an overdraft over a large population of users and transactions is small enough to be tolerable to users.

In a presently preferred but non-limiting embodiments, acquirers supporting Automated Fuel Dispensers (AFD) should be required to submit an Authorization Advice/0120 message within 60 minutes after every AFD transaction to notify the issuer of the amount the cardholder spent at the AFD; and issuers must remove holds on accounts listed on these Authorization Advice/0120 messages within 2 hours of the AFD transaction completion. In an alternative statement, issuers must remove holds on accounts within 1 hour from the receipt of authorization advice message.

It is to be emphasized that these exemplary time periods are non-limiting and could be different in other embodiments. For example, in some cases, such “immediate” sending of the authorization advice message might be achieved if it is sent within twenty minutes of completion of the purchase, with the issuer correcting the open to buy amount within at most two hours from completion of the transaction. Where appropriate and feasible, both sending of the authorization advice and correcting the open to buy amount may be completed as soon as possible.

Issuers 210 use the advice message to adjust the excessive funds hold, to the actual amount of the sale upon receipt of the advice message. In one or more embodiments, this is done for both nominal (for example, $1) authorization amounts (as discussed below) and estimated amount authorizations. Advantageously, one or more embodiments of the invention, employing this approach, have a tolerable impact on the merchant 204 and acquirer 206, in that they are now required to submit the advice message immediately (as defined above). Furthermore, one or more embodiments also have a tolerable impact on the issuer 210, requiring reconciliation of the “hold” amount based on the advice message. Finally, one or more embodiments have a tolerable (typically no) impact on the operator of the payment network 208, which merely employs existing functionality.

Reference should now be had to FIG. 3, which depicts exemplary transaction flow for the authorization advice message using the actual transaction amount. Reference should also be had to FIG. 4, which depicts one exemplary architecture appropriate for one or more embodiments of the invention. For the avoidance of doubt, blocks 330 and 368 are intended as an abbreviation of “REMOVE $40 HOLD APPLY $40 TRANSACTION TO ACCOUNT” and block 348 is intended as an abbreviation of “ACCOUNT BALANCE ONLY $50 APPLY $50 HOLD AGAINST OTB.” Furthermore, for the avoidance of doubt, in FIG. 4, block 122, 124, 125, 126 reads “reader/communication device”; block 204 reads “automated fuel dispenser at merchant location”; block 490 reads “Fuel Pump,” block 206 reads “Acquirer Processor,” the data store labeled 154, 414, 426, 434 reads “Account,” block 210 reads “Issuer Processor,” blocks 404, 406, 408, and 410 read “Authorization,” blocks 418 and 420 read “Purchase Completion,” blocks 428, 430, and 432 read “Clearing & Settlement,” block 422 reads “Routing,” the block labeled 412, 424 reads “Account Management,” and the block with elements 408, 422, 430 is labeled at the bottom “payment network.”

As shown at 302, 304, a first example involves a nominal $1 pre-authorization wherein a full predetermined amount (here, $100 charge back (CB) protection amount) is approved. In particular, responsive to presentation of the debit card 102, 112, 150 by the user 202 (for example, at the gasoline or other fuel pump 490), the acquirer (possibly via acquirer processor) 206 submits an MTI 0100 Authorization Request (pre-authorization format) message 306. The request may include a nominal amount (e.g., $1), an estimated amount based on an algorithm or the like, the maximum amount (predetermined chargeback amount, say, $100), or even an amount greater than the chargeback amount, in any case determined by the acquirer 206 or merchant 204. In the example, data element 4 (DE4), the (nominal) transaction amount is $1, while DE18, the merchant type, is 5542. Submission of the $1 authorization request MTI 0100 by the merchant and acquirer is depicted at 308.

There is a terminal 122, 124, 125, 126 associated with the fuel pump 490. For the avoidance of doubt, the text adjacent to 122, 124, 125, 126 in FIG. 4 reads “reader/communication device”). The fuel pump and terminal are located in an automated fuel dispenser at a merchant location 204. Presentation of the card is shown at 402 in FIG. 4 while interaction with the fuel pump is shown at 416 in FIG. 4. Appropriate modules 404 and 418 are provided for authorization and purchase completion, respectively, as shown at 404, 418. The terminal communicates with acquirer processor 206 over a suitable network 138. The acquirer processor 206 may have, for example, a suitable platform including modules for authorization, purchase completion, and clearing & settlement, as shown at, respectively, 406, 420, and 428. The authorization request may be sent to issuer (including in some instances an issuer processor) 210 over payment network 208. At a suitable node location within the payment network 208, a platform can be provided with modules for authorization, routing, and clearing & settlement, as shown at, respectively, 408, 422, and 430. Issuer processor 210 may have a platform with modules for authorization, account management, and clearing & settlement, as shown at, respectively, 410, 412/424, and 432. A suitable data store 154 maintains account data as indicated at 414, 426, and 434. Please note that the following table lists blocks from the flow diagram of FIG. 3 on the left with the corresponding elements in FIG. 4 on the right, it being understood that such elements correspond to such flows, in one or more embodiments. Elements in FIG. 4 may also correspond to the analogous flows at 340, 342 of FIG. 3.

302
304
306
308 →310
310
314
316
318
320
320 →322
322, 324
328
328 →330
330
402
404
406
408
410, 412
414
416
418
420
422
424, 426
428
430
432, 434

As shown at 310 and 314, the issuer 210 generates an MTI 0110 Authorization Request Response message for, in this exemplary case the full CB amount (that is, the $100 hold for purposes of protecting the merchant 204, and not the nominal $1 transaction amount). As discussed below with respect to 340, 342, in some cases, where, for example, the full CB amount is not available, a lesser amount as determined by the issuer is authorized, if the acquirer supports partial approvals. The $100 is held against the OTB (open to buy) associated with the debit card account. The OTB abbreviation is provided in the figure at 370 for the convenience of the reader. Normal merchant protection rules apply. Upon receipt of the MTI 0110, merchant 204 sets the pump to the $100 CB (charge back) protection level, as at 316. Note that an exemplary charge back amount of $100 has been used herein, but any desired predetermined value can be employed; furthermore, different amounts can be used for consumer cards, commercial (e.g., fleet) or corporate cards, and so on.

The skilled artisan will appreciate that, with regard to the chargeback (CB) amount, appropriate rules may be in place such that, for example, the issuer cannot charge back a transaction effected with any other branded payment card and processed at a cardholder-activated automated fuel dispenser card acceptor located in the a region (e.g., the USA) for any amount less than or equal to the predetermined chargeback amount, if the transaction was suitable identified in the authorization request (for example, with MCC 5542 and CAT 2), and authorized by the issuer for the appropriate nominal amount (e.g., USD 1). If the transaction amount exceeds the CB amount, the issuer may charge back only the difference between the transaction amount and chargeback amount.

When the transaction is completed, as shown at 320, the acquirer 206 sends an MTI 0120 Authorization Advice message 318 containing the final transaction amount (in this case, $40). The issuer 210 acknowledges the transaction using an MTI 0130 Authorization Advice Response message, as shown at 324. As in block 322, the issuer 210 releases the excessive hold based on the MTI 0120 advice message, by changing the CB amount (e.g., $100) held against the OTB balance to the actual transaction amount of $40 (i.e., reducing the hold to $40). Note that in one or more embodiments, if the transaction is terminated after the pre-authorization, the acquirer and/or merchant 206, 204 must send the issuer 210 a reversal message (a non-limiting example thereof is an MTI 0400). As shown at 326, 328, the acquirer 206 receives the MTI 0130 advice acknowledgement and in response, submits the clearing message containing the final amount ($40), which is equal to the amount contained in the advice message. The issuer 210, as shown at 330, removes the final amount of $40 from the OTB balance and applies the $40 transaction to the underlying DDA (i.e., removes the $40 hold and applies a $40 transaction to the account).

The skilled artisan, given the teachings herein, will be able to construct a suitable authorization advice message; such message may include one, some, or all of, for example: the MTI; primary account number (PAN); special code(s) to identify the type of message and/or automated fuel dispenser (AFD)-type transaction; the various currency amounts and types, dates and times; card expiration date; any currency conversion data; merchant type; country codes; security data; data identifying the terminal and/or transaction; auditing data; a reason code that explains the reason for the message (e.g., AFD-type transaction); and the like. One non-limiting example of an authorization advice message is the MTI 0120 message, based on ISO 8583 and published in MasterCard's CIS (Customer Interface Specification) manual. It is to be emphasized that various specific message types are set forth herein, for example, in terms of message type indicators. These are intended to be exemplary and non-limiting in nature, and one or more embodiments of the invention can make use of a variety of different messages containing the same or similar information as the specific non-limiting examples set forth herein.

As shown at 340, 342, a second example involves an acquirer 206 which supports partial approvals. A nominal (e.g., $1) pre-authorization amount is submitted (any appropriate amount can be used as set forth above). In this case, the full predetermined amount (here, $100 CB) cannot be approved, but rather only $50 can be approved. In particular, responsive to presentation of the debit card (for example, at the gasoline pump), the acquirer 206 submits an MTI 0100 Authorization Request (pre-authorization format) message 344. By pre-agreement, the issuer treats this as a request for the maximum amount (predetermined chargeback amount, say, $100) as determined by the acquirer 206 or merchant 204. In the example, data element 4 (DE4), the transaction amount is $1; DE18, the merchant type, is 5542; and DE48 (additional data—private) has a value of 4 indicating partial approval capability. In a non-limiting example, to indicate partial approval allowed use DE48 SE61 Pos 1 (not 7), and the value is 1. There is a DE61 SF7 value 4 that indicates this MTI 0100 is a pre-auth. Submission of the $1 authorization request MTI 0100 by the merchant and acquirer is depicted at 346. As shown at 348 and 352, the issuer 210 generates an MTI 0110 Authorization Request Response message for only part of the full amount (that is, $50 of the $100 CB hold for purposes of protecting the merchant 204, and not the nominal $1 transaction amount; $50 rather than $100 because in this example, the account balance is only $50). The $50 is held against the OTB associated with the debit card account (i.e., account balance only $50; apply $50 hold against OTB). The $50 may be indicated by a DE95 replacement amount of $50, as shown at 350. In one or more embodiments, the $50 is placed in DE 06 by the issuer to identify the amount they are approving in the cardholder's currency. The operator of the payment network 208 then builds DE 04, based on doing currency conversion if needed. The transaction amount from the original auth is placed into DE 54. Normal merchant protection rules apply. Upon receipt of the MTI 0110, merchant 204 sets the pump to the $50 partial level, as at 354. Again, all the MTI values, data elements (DE), sub-elements (SE), sub-fields (SF), and the like are purely exemplary and not intended to be limiting; other messages, elements, and/or fields conveying the same or similar information can be employed in other embodiments.

When the transaction is completed, as shown at 358, the acquirer 206 sends an MTI 0120 Authorization Advice message 356 containing the final transaction amount (in this case, $40). The issuer 210 acknowledges the transaction using an MTI 0130 Authorization Advice Response message, as shown at 362. As in block 360, the issuer 210 releases the excessive hold based on the MTI 0120 advice message, by changing the $50 amount held against the OTB balance to the actual transaction amount of $40 (i.e., reduce hold to $40). Note that in one or more embodiments, if the transaction is terminated after the pre-authorization, the acquirer and/or merchant 206, 204 must send the issuer 210 a reversal message as discussed above. As shown at 364, 366, the acquirer 206 receives the MTI 0130 advice acknowledgement and in response, submits the clearing message containing the final amount ($40), which is equal to the amount contained in the advice message. The issuer 210, as shown at 368, removes the final amount of $40 from the OTB balance and applies the $40 transaction to the underlying DDA (i.e., removes the $40 hold and applies a $40 transaction to the account).

Advantageously, one or more embodiments of the invention provide one or more of the following benefits:
Current Industry Practice: Approach based on current industry practices and relying on existing system capabilities; requires minimal changes to merchants, acquirer, issuers and payment network systems.
Works like single-message: Analogous to single-message advice mechanism (potentially reducing required messaging bandwidth).

Advantageously, one or more embodiments of the invention have tolerable impact on the parties:
Merchant—The merchant must immediately (as defined above) send a second message to reconcile the transaction to the final amount.
Acquirer—Must be capable of immediately processing the advice transaction. “Immediate” in the context of an Acquirer means consistency with the goals set forth above; the acquirer must generate initiation of the authorization advice with actual amount upon completion of the sale, to meet the goals set forth above.
Issuer—Must reconcile the hold amount immediately upon receipt of the advice message. “Immediate” in the context of an Issuer means sufficiently fast to meet the goals set forth above, preferably upon receipt of the authorization advice.
Payment Network Operator—Little or none (in one or more embodiments, should ensure straight-through processing, or immediate processing, of advice message)

Given the discussion thus far, it will be appreciated that, in general terms, an exemplary method includes the step of facilitating placement of a hold amount against a payment card account of a customer, in response to the customer presenting a payment device, associated with the payment card account, in connection with a non-PIN, signature-based, dual message transaction with a merchant. The presenting of the payment device is prior to a time when an amount of the transaction can be determined. A non-limiting example of this step includes issuer 210 carrying out step 310 (or 348), and/or acquirer 206 and network operator 208 facilitating step 310 (or 348) by transmitting message 306 (or 344) as at step 308 (or 346). The step could be carried out using, for example, card reader hardware obtaining data for transmission to the acquirer 206, with formation of message 306 (or 344) (for example, by an acquirer platform including software running on one or more hardware processors at the acquirer) for transmission by operator 208 over a VPN (including hardware elements) as discussed with respect to FIG. 2, to a server of issuer 210 running issuer platform software. Non-limiting details of one specific architecture have been discussed above with respect to FIG. 4.

An additional step, carried out subsequent to the placement of the hold amount, immediately after the time when the amount of the transaction can be determined, includes facilitating transmission of an authorization advice message from an acquirer associated with the merchant to an issuer of the payment device. The authorization advice message indicates the amount of the transaction. A non-limiting example of this step includes sending formation of MTI 0120 message 318 (or 356) for transmission by network 208 as at step 320 (or 358) (facilitated, for example, by sending data indicative of the actual transaction amount to the acquirer for message formation). The step could be carried out using, for example, hardware (for example, electronic components of a gasoline pump) at the merchant's location to send the data to acquirer with formation of message 318 (or 356) (for example, by an acquirer platform including software running on one or more hardware processors at the acquirer) for transmission by operator 208 over the VPN, to a server of issuer 210. Again, non-limiting details of one specific architecture have been discussed above with respect to FIG. 4.

A further step includes facilitating the issuer of the payment device releasing any portion of the hold amount which exceeds the amount of the transaction, immediately (as discussed above) responsive to the authorization advice message receipt. A non-limiting example of this step includes issuer 210 carrying out step 322 (or 360). The step could be carried out using, for example, server of issuer 210 running issuer platform software. Yet again, non-limiting details of one specific architecture have been discussed above with respect to FIG. 4.

As used herein, a non-PIN transaction is one that is carried out without entry of a personal identification number (“PIN”) by the user to authorize payment. Furthermore, as used herein, including the claims, a signature-based, dual-message transaction is one wherein an initial authorization hold is placed against the account, with clearing and settlement occurring later, typically in a batch mode as described above, whether or not a physical or electronic signature is actually obtained. For example, in a typical automated fuel dispenser scenario, no signature is obtained even though the transaction is signature based within this definition.

In one or more embodiments, the payment card account is a debit card account. One or more embodiments may be particularly useful with respect to debit accounts because in the credit scenario, the credit line (virtual credit limit) is usually relatively large and the hold amount does not cause difficulty (but hold amounts may become more of a concern with respect to credit in the current economic environment as credit limits shrink). Note that the payment card account can be consumer, corporate, fleet, and the like. Note also that from the acquirer side implementing the authorization advice for both debit and credit likely makes little difference and actually may be easier than implementing the authorization advice only for debit Issuers could thus have the option to manage the open to buy.

Additional steps that may be carried out include facilitating comparing a predetermined protection amount against an amount available from the debit card account; and facilitating placing the hold amount against the debit card account only when the amount available from the debit card account is at least as much as the predetermined protection amount, with the hold amount comprising the predetermined protection amount. These steps may be present in step 310 and may be carried out, for example, by the issuer platform software running on a server of the issuer. If the amount available from the debit card account is not at least as much as the predetermined protection amount, the transaction may be denied.

Another optional step, where partial approval is possible, includes facilitating calculating the hold amount as the lesser of a predetermined protection amount and an amount available from the debit card account. This step may be present in step 348 and may be carried out, for example, by the issuer platform software running on a server of the issuer.

One or more embodiments of the invention are of use, for example, whenever a debit card or other payment device linked to a DDA is presented before an actual amount of a transaction is known. In a preferred but non-limiting embodiment, the merchant comprises a filling station, the transaction is a purchase of fuel, the customer presents the payment device prior to the purchase of the fuel, and the time when the amount of the transaction can be determined is a time when a fuel dispenser associated with the transaction has been shut off.

Non-limiting details of one specific architecture for implementing one, some, or all of the optional steps have been discussed above with respect to FIG. 4.

### System and Article of Manufacture Details

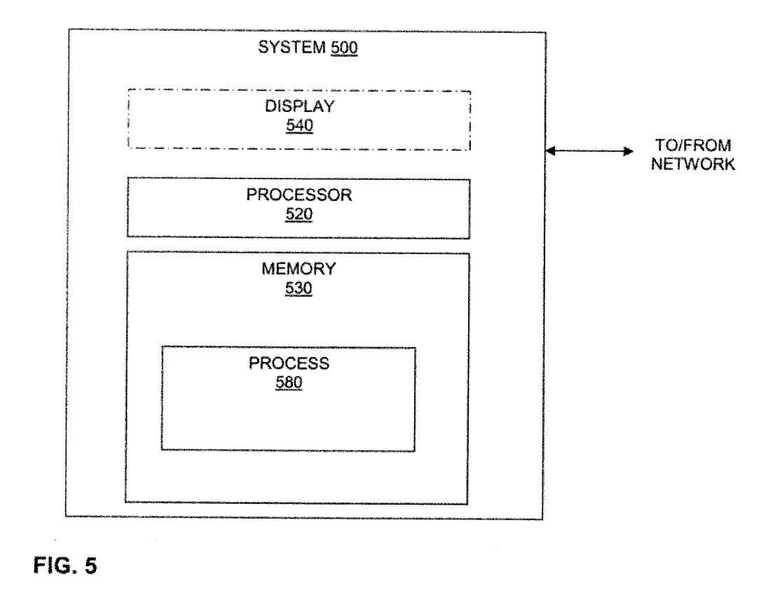

The invention can employ hardware and/or hardware and software aspects. Software includes but is not limited to firmware, resident software, microcode, etc. Software might be employed, for example, in connection with one or more of a terminal 122, 124, 125, 126, a reader 132, a processing center 140, 142, 144 (optionally with data warehouse 154) of a merchant, issuer, acquirer, processor, or payment processing network operator, and/or any of the modules, platforms, or other elements in FIG. 4. Firmware might be employed, for example, in connection with payment devices such as cards 102, 112. FIG. 5 is a block diagram of a system 500 that can implement part or all of one or more aspects or processes of the invention. As shown in FIG. 5, memory 530 configures the processor 520 (which could correspond, e.g., to processor portions 106, 116, 130, processors of remote hosts in centers 140, 142, 144, processors of servers associated with the modules, platforms, or other elements in FIG. 4, and the like) to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a storage medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a server or processing center. As used herein, a tangible computer-readable recordable storage medium is intended to encompass a recordable medium, examples of which are set forth above, but is not intended to encompass a transmission medium or disembodied signal. A tangible computer-readable recordable storage medium thus embodies instructions in a non-transitory manner.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144, in the modules, platforms, or other elements in FIG. 4, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned terminals 122, 124, 125, 126, processing centers 140, 142, 144 with data warehouse 154, payment devices such as cards 102, 112, or servers of the modules, platforms, or other elements in FIG. 4, can make use of computer technology with appropriate instructions to implement method steps described herein. By way of further example, a terminal apparatus 122, 124, 125, 126, could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, mouse or other input/output components. A “host” includes a physical data processing system (for example, system 500 as shown in FIG. 5) running an appropriate program.

Furthermore, it should be noted that any of the methods described herein can include an additional step of providing a system comprising distinct software modules embodied on a tangible computer readable recordable storage medium. All the modules (or any subset thereof) can be on the same medium, or each can be on a different medium, for example. The modules can include any or all of the components shown in the figures. In one or more embodiments, the modules include the modules, platforms, or other elements in FIG. 4 (e.g., acquirer platform module implements block 206 and sub-blocks; issuer platform module implements block 210 and sub-blocks). The method steps can then be carried out using the distinct software modules of the system, as described above, executing on one or more hardware processors. For example, each of the modules, platforms, or other elements in FIG. 4 could execute on a different hardware processor of a different server; the elements 406, 420, 428 could be on the same server with elements 410, 412/424, 432 on a separate server, and so on. Further, a computer program product can include a tangible computer-readable recordable storage medium with code adapted to be executed to carry out one or more method steps described herein, including the provision of the system with the distinct software modules. The distinct software modules implementing the platforms in FIG. 4 could include sub-modules to implement the functionality of elements such as 406, 420, 428 depicted therein.

Computers discussed herein can be interconnected, for example, by one or more of network 138, 208, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic depicted in the flow charts and other figures.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
facilitating placement of a hold amount against a payment card account of a customer, in response to said customer presenting a payment device, associated with said payment card account, in connection with a non-PIN, signature-based, dual-message transaction with a merchant, said presenting of said payment device being prior to a time when an amount of said transaction can be determined;
subsequent to said placement of said hold amount, immediately after said time when said amount of said transaction can be determined, facilitating transmission of an authorization advice message from an acquirer associated with said merchant to an issuer of said payment device, said authorization advice message indicating said amount of said transaction; and
facilitating said issuer of said payment device releasing any portion of said hold amount which exceeds said amount of said transaction, immediately responsive to said authorization advice message.

2. The method of claim 1, wherein said payment card account comprises a debit card account.

3. The method of claim 2, further comprising:
facilitating comparing a predetermined protection amount against an amount available from said debit card account; and
facilitating placing said hold amount against said debit card account only when said amount available from said debit card account is at least as much as said predetermined protection amount, said hold amount comprising said predetermined protection amount.

4. The method of claim 2, further comprising:
facilitating calculating said hold amount as the lesser of a predetermined protection amount and an amount available from said debit card account.

5. The method of claim 2, wherein:
said merchant comprises a filling station;
said transaction comprises a purchase of fuel;
said customer presents said payment device prior to said purchase of said fuel; and
said time when said amount of said transaction can be determined comprises a time when a fuel dispenser associated with said transaction has been shut off.

6. The method of claim 1, further comprising providing a system, wherein the system comprises distinct software modules, each of the distinct software modules being embodied on tangible a computer-readable recordable storage medium, and wherein the distinct software modules comprise an issuer platform module and an acquirer platform module;
wherein:
said step of facilitating said placement of said hold amount is carried out, at least in part, by said issuer platform module executing on at least one hardware processor;
said step of facilitating said transmission of said authorization advice message is carried out, at least in part, by said acquirer platform module executing on said at least one hardware processor; and
said step of facilitating said issuer of said payment device releasing said any portion of said hold amount which exceeds said amount of said transaction is carried out, at least in part, by said issuer platform module executing on said at least one hardware processor.

7. A computer program product comprising a tangible computer readable recordable storage medium having computer readable program code embodied therewith, said computer readable program code comprising:
computer readable program code configured to facilitate placement of a hold amount against a payment card account of a customer, in response to said customer presenting a payment device, associated with said payment card account, in connection with a non-PIN, signature-based, dual-message transaction with a merchant, said presenting of said payment device being prior to a time when an amount of said transaction can be determined;
computer readable program code configured to, subsequent to said placement of said hold amount, immediately after said time when said amount of said transaction can be determined, facilitate transmission of an authorization advice message from an acquirer associated with said merchant to an issuer of said payment device, said authorization advice message indicating said amount of said transaction; and
computer readable program code configured to facilitate said issuer of said payment device releasing any portion of said hold amount which exceeds said amount of said transaction, immediately responsive to said authorization advice message.

8. The computer program product of claim 7, wherein said payment card account comprises a debit card account.

9. The computer program product of claim 8, further comprising:
computer readable program code configured to facilitate comparing a predetermined protection amount against an amount available from said debit card account; and
computer readable program code configured to facilitate placing said hold amount against said debit card account only when said amount available from said debit card account is at least as much as said predetermined protection amount, said hold amount comprising said predetermined protection amount.

10. The computer program product of claim 8, further comprising:
computer readable program code configured to facilitate calculating said hold amount as the lesser of a predetermined protection amount and an amount available from said debit card account.

11. The computer program product of claim 10, wherein:
said merchant comprises a filling station;
said transaction comprises a purchase of fuel;
said customer presents said payment device prior to said purchase of said fuel; and
said time when said amount of said transaction can be determined comprises a time when a fuel dispenser associated with said transaction has been shut off.

12. An apparatus comprising:
a memory; and
at least one processor, coupled to said memory, and operative to:
facilitate placement of a hold amount against a payment card account of a customer, in response to said customer presenting a payment device, associated with said payment card account, in connection with a non-PIN, signature-based, dual-message transaction with a merchant, said presenting of said payment device being prior to a time when an amount of said transaction can be determined;
subsequent to said placement of said hold amount, immediately after said time when said amount of said transaction can be determined, facilitate transmission of an authorization advice message from an acquirer associated with said merchant to an issuer of said payment device, said authorization advice message indicating said amount of said transaction; and
facilitate said issuer of said payment device releasing any portion of said hold amount which exceeds said amount of said transaction, immediately responsive to said authorization advice message.

13. The apparatus of claim 12, wherein said payment card account comprises a debit card account.

14. The apparatus of claim 13, wherein said at least one processor is further operative to:
facilitate comparing a predetermined protection amount against an amount available from said debit card account; and
facilitate placing said hold amount against said debit card account only when said amount available from said debit card account is at least as much as said predetermined protection amount, said hold amount comprising said predetermined protection amount.

15. The apparatus of claim 13, wherein said at least one processor is further operative to:
facilitate calculating said hold amount as the lesser of a predetermined protection amount and an amount available from said debit card account.

16. The apparatus of claim 15, wherein:
said merchant comprises a filling station;
said transaction comprises a purchase of fuel;
said customer presents said payment device prior to said purchase of said fuel; and
said time when said amount of said transaction can be determined comprises a time when a fuel dispenser associated with said transaction has been shut off.

17. The apparatus of claim 12, further comprising a plurality of distinct software modules embodied in a non-transitory fashion on a tangible, computer-readable, recordable storage medium, wherein the distinct software modules comprise an issuer platform module and an acquirer platform module;
wherein:
said at least one processor is operative to facilitate said placement of said hold amount, at least in part, by executing said issuer platform module;
said at least one processor is operative to facilitate said transmission of said authorization advice message, at least in part, by executing said acquirer platform module; and
said at least one processor is operative to facilitate said issuer of said payment device releasing said any portion of said hold amount which exceeds said amount of said transaction, at least in part, by executing said issuer platform module.

18. An apparatus comprising:
means for facilitating placement of a hold amount against a payment card account of a customer, in response to said customer presenting a payment device, associated with said payment card account, in connection with a non-PIN, signature-based, dual-message transaction with a merchant, said presenting of said payment device being prior to a time when an amount of said transaction can be determined;
means for, subsequent to said placement of said hold amount, immediately after said time when said amount of said transaction can be determined, facilitating transmission of an authorization advice message from an acquirer associated with said merchant to an issuer of said payment device, said authorization advice message indicating said amount of said transaction; and
means for facilitating said issuer of said payment device releasing any portion of said hold amount which exceeds said amount of said transaction, immediately responsive to said authorization advice message.

19. The apparatus of claim 18, wherein said payment card account comprises a debit card account.

20. The apparatus of claim 19, wherein:
said merchant comprises a filling station;
said transaction comprises a purchase of fuel;
said customer presents said payment device prior to said purchase of said fuel; and
said time when said amount of said transaction can be determined comprises a time when a fuel dispenser associated with said transaction has been shut off.
